(19) United States
(12) Patent Application Publication
(10) Pub. No.: US 2007/0070904 A1
(43) Pub. Date: Mar. 29, 2007

(54) Feedback mechanism for flexible load balancing in a flow-based processor affinity scheme

(76) Inventors: Steven R. King, Portland, OR (US); Erik J. Johnson, Portland, OR (US); Stephen D. Goglin, Hillsboro, OR (US)

Correspondence Address: INTEL CORPORATION;C/O INTELLEVATE, LLC, P.O. BOX 52050, MINNEAPOLIS, MN, 55402, US

(21) Appl. No.: 11/235,876

(22) Filed: Sep. 26, 2005

(51) Int. Cl. H04J 1/16; H04L 12/56

(52) U.S. Cl. 370/235; 370/389

(57) ABSTRACT

In an embodiment, a method is provided. The method of this embodiment provides directing one or more packets to a first processor of a plurality of processors based, at least in part, on a flow associated with the one or more packets; and receiving from one of the plurality of processors a signal indicating a request to redirect one or more subsequent packets associated with the one processor to one or more other processors of the plurality of processors.

### FIELD

Embodiments of this invention relate to a feedback mechanism for flexible load balancing in a flow-based processor affinity scheme.

### BACKGROUND

Processor affinity refers to the mapping of an object, process, resource, or application, for example, to a particular processor. Processor affinity may be used to control processors to limit demands on system resources. For example, a flow-based processor affinity scheme may be used to direct packets to particular processors based on the flow of the packets. As used herein, a “flow” refers to information that may be used by a computing platform to manage information about a particular connection. For example, when a transmitting computer establishes a connection with a receiving system, the flow may comprise one or more connection parameters including, for example, source address, destination address, local port, remote port, and sequence number for each direction. A flow may be accessed during packet processing, when a packet may be parsed for information that may include one or more connection parameters related to the connection.

Currently known implementations of flow-based processor affinity have limitations. For example, Receive Side Scaling (hereinafter “RSS”) is an example of flow-based processor affinity. RSS is part of a future version of the Network Device Interface Specification (hereinafter “NDIS”) in the Microsoft® Windows® family of operating systems. As of the filing date of the subject application, the NDIS version that will include RSS capabilities is currently known to be NDIS 6.0 available from Microsoft® Corporation. RSS is described in “Scalable Networking With RSS”, WinHEC (Windows Hardware Engineering Conference) 2005, Apr. 19, 2005 (hereinafter “the WinHEC Apr. 19, 2005 white paper”).

In RSS, for example, a network controller may direct packets it receives off the network to one or more processors using a mapping table that may be configured in accordance with a flow-based processor affinity scheme. For example, a hash function may be calculated over bits of a packet to derive a hash value that correlates to the packet's flow. This procedure requires that the network controller be explicitly configured so that each packet can be directed to a specified processor. Periodically, the host protocol stack may modify the mapping table to rebalance the processing load such as when, for example, a processor becomes overloaded with packets either from a single flow, or from multiple flows, or when a processor becomes underutilized. However, the rebalancing procedure may be a complex procedure requiring, for example, recalculation of a hash function and re-specifying bits in a packet header over which to calculate the hash function. This may make dynamic adjustment of the mapping table inefficient.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a system according to an embodiment.

FIG. 2 illustrates a mapping table according to an embodiment.

FIG. 3 is a flowchart illustrating a method according to an embodiment.

FIG. 4 is a block diagram illustrating one example of packets being redirected.

FIG. 5 is a block diagram illustrating another example of packets being redirected.

### DETAILED DESCRIPTION

Examples described below are for illustrative purposes only, and are in no way intended to limit embodiments of the invention. Thus, where examples may be described in detail, or where examples may be provided, it should be understood that the examples are not to be construed as exhaustive, and do not limit embodiments of the invention to the examples described and/or illustrated.

Briefly, an embodiment of the present invention relates to a computing platform comprising a network controller and a plurality of processors. The network controller may receive packets and direct them to one of the plurality of processors based, at least in part, on the flow of the packet. Each of the plurality of processors is operable to provide a signal to the network controller indicating a request to redirect packets from one processor to one or more of the other processors.

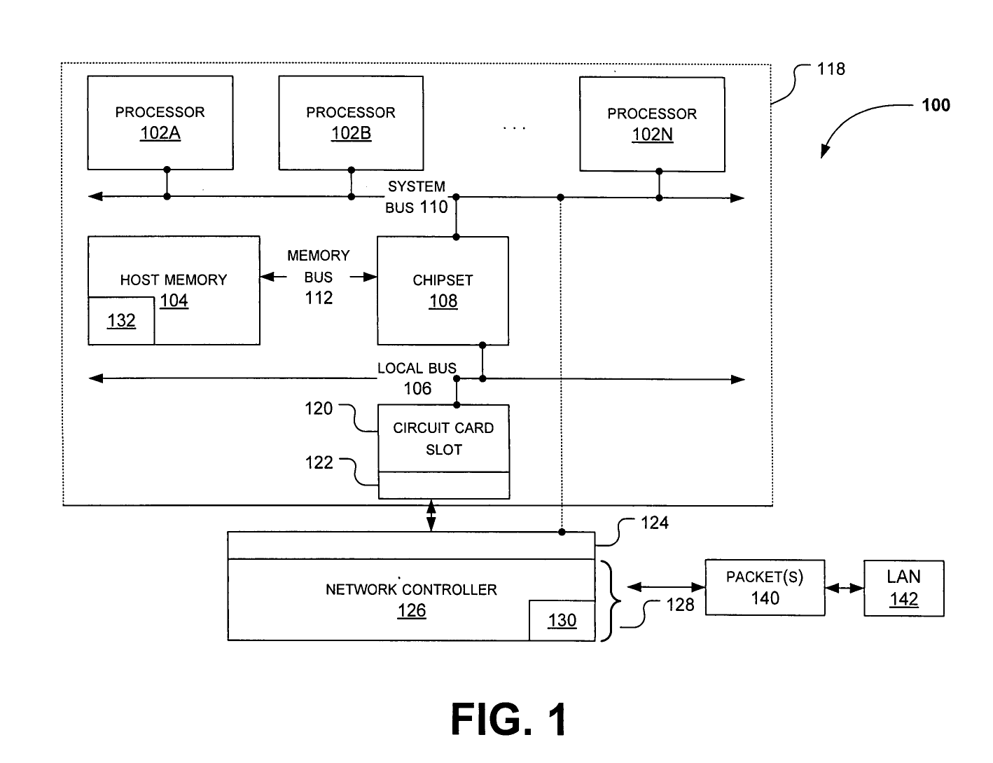

As illustrated in FIG. 1, computing platform 100 may comprise a plurality of processors 102A, 102B, . . . , 102N. In an embodiment, one or more processors 102A, 102B, . . . , 102N may perform substantially the same functions. For example, any one or more processors 102A, 102B, . . . , 102N may comprise, for example, an Intel® Pentium® microprocessor that is commercially available from the Intel® Corporation. Of course, alternatively, any of processors 102A, 102B, . . . , 102N may comprise another type of processor, such as, for example, a microprocessor that is manufactured and/or commercially available from Intel® Corporation, or a source other than Intel® Corporation, without departing from embodiments of the invention. In an embodiment, alternatively, each processor 102A, 102B, . . . , 102N may comprise a computational engine that may be comprised in a multi-core processor, for example, where each computational engine may be perceived as a discrete processor with a full set of execution resources. Each of plurality of processors 102A, 102B, . . . , 102N may each be communicatively coupled to system bus 110 to communicate with other components. However, other configurations are possible.

Memory 104 may store machine-executable instructions 132 that are capable of being executed, and/or data capable of being accessed, operated upon, and/or manipulated by logic, such as logic 130. “Machine-executable” instructions as referred to herein relates to expressions which may be understood by one or more machines for performing one or more logical operations. For example, machine-executable instructions may comprise instructions which are interpretable by a processor compiler for executing one or more operations on one or more data objects. However, this is merely an example of machine-executable instructions and embodiments of the present invention are not limited in this respect. Memory 104 may, for example, comprise read only, mass storage, random access computer-accessible memory, and/or one or more other types of machine-accessible memories. The execution of program instructions 132 and/or the accessing, operation upon, and/or manipulation of this data by logic 130 for example, may result in, for example, system 100 and/or logic 130 carrying out some or all of the operations described herein.

Logic 130 may comprise hardware, software, or a combination of hardware and software (e.g., firmware). For example, logic 130 may comprise circuitry (i.e., one or more circuits), to perform operations described herein. Logic 130 may be hardwired to perform the one or more operations. For example, logic 130 may comprise one or more digital circuits, one or more analog circuits, one or more state machines, programmable logic, and/or one or more ASIC's (Application-Specific Integrated Circuits). Alternatively or additionally, logic 130 may be embodied in machine-executable instructions 132 stored in a memory, such as memory 104, to perform these operations. Alternatively or additionally, logic 130 may be embodied in firmware. Logic may be comprised in various components of system 100, including network controller 126 (as illustrated), chipset 108, one or more processors 102A, 102B, . . . , 102N, and on motherboard 118. Logic 130 may be used to perform various functions by various components as described herein.

Chipset 108 may comprise a host bridge/hub system that may couple processor 102A, 102B, . . . , 102N, and host memory 104 to each other and to local bus 106. Chipset 108 may comprise one or more integrated circuit chips, such as those selected from integrated circuit chipsets commercially available from Intel® Corporation (e.g., graphics, memory, and I/O controller hub chipsets), although other one or more integrated circuit chips may also, or alternatively, be used. According to an embodiment, chipset 108 may comprise an input/output control hub (ICH), and a memory control hub (MCH), although embodiments of the invention are not limited by this. Chipset 108 may communicate with memory 104 via memory bus 112 and with host processor 102A,102B, . . . , 102N via system bus 110. In alternative embodiments, host processor 102A, 102B, . . . , 102N and host memory 104 may be coupled directly to bus 106, rather than via chipset 108.

Local bus 106 may be coupled to a circuit card slot 120 having a bus connector 122. Local bus 106 may comprise a bus that complies with the Peripheral Component Interconnect (PCI) Local Bus Specification, Revision 3.0, Feb. 3, 2004 available from the PCI Special Interest Group, Portland, Oreg., U.S.A. (hereinafter referred to as a “PCI bus”). Alternatively, for example, bus 106 may comprise a bus that complies with the PCI Express™ Base Specification, Revision 1.1, Mar. 28, 2005 also available from the PCI Special Interest Group (hereinafter referred to as a “PCI Express bus”). Bus 106 may comprise other types and configurations of bus systems.

System 100 may additionally include a network controller. A “network controller” as referred to herein relates to a device which may be coupled to a communication medium to transmit data to and/or receive data from other devices coupled to the communication medium, i.e., to send and receive network traffic. For example, a network controller may transmit packets 140 to and/or receive packets 140 from devices coupled to a network such as a local area network 142. As used herein, a “packet” means a sequence of one or more symbols and/or values that may be encoded by one or more signals transmitted from at least one sender to at least one receiver. Such a network controller 126 may communicate with other devices according to any one of several data communication formats such as, for example, communication formats according to versions of IEEE Std. 802.3, IEEE Std. 802.11, IEEE Std. 802.16, Universal Serial Bus, Firewire, asynchronous transfer mode (ATM), synchronous optical network (SONET) or synchronous digital hierarchy (SDH) standards.

In an embodiment, network controller 126 may be communicatively coupled to local bus 106, and be comprised on system motherboard 118. Network controller 126 may comprise logic 130 to perform operations described herein. As used herein, components that are “communicatively coupled” means that the components may be capable of communicating with each other via wirelined (e.g., copper or optical wires), or wireless (e.g., radio frequency) means.

Rather than reside on motherboard 118, network controller 126 may be integrated onto chipset 108, or may instead be comprised in a circuit card 128 (e.g., NIC or network interface card) that may be inserted into circuit card slot 120. Circuit card slot 120 may comprise, for example, a PCI expansion slot that comprises a PCI bus connector 122. PCI bus connector 122 may be electrically and mechanically mated with a PCI bus connector 124 that is comprised in circuit card 128. Circuit card slot 120 and circuit card 128 may be constructed to permit circuit card 128 to be inserted into circuit card slot 120. When circuit card 128 is inserted into circuit card slot 120, PCI bus connectors 122,124 may become electrically and mechanically coupled to each other. When PCI bus connectors 122, 124 are so coupled to each other, logic 130 in circuit card 128 may become electrically coupled to system bus 110.

In an embodiment, rather than be communicatively coupled to local bus 106, network controller 126 may instead be communicatively coupled to a dedicated bus on the MCH of chipset 108. For example, dedicated bus may comprise a bus that complies with CSA (Communication Streaming Architecture). CSA is a communications interface technology developed by Intel® that directly connects the MCH to the network controller to improve the transfer rate of network data and to eliminate network traffic passing through the PCI bus. Alternatively, network controller 126 may be communicatively coupled to system bus 110, either as a circuit card 124 inserted into a circuit card slot communicatively coupled to system bus 110 (this circuit card slot not illustrated), for example, or as a network controller located on motherboard 118 or integrated into chipset 108 and coupled to system bus 110.

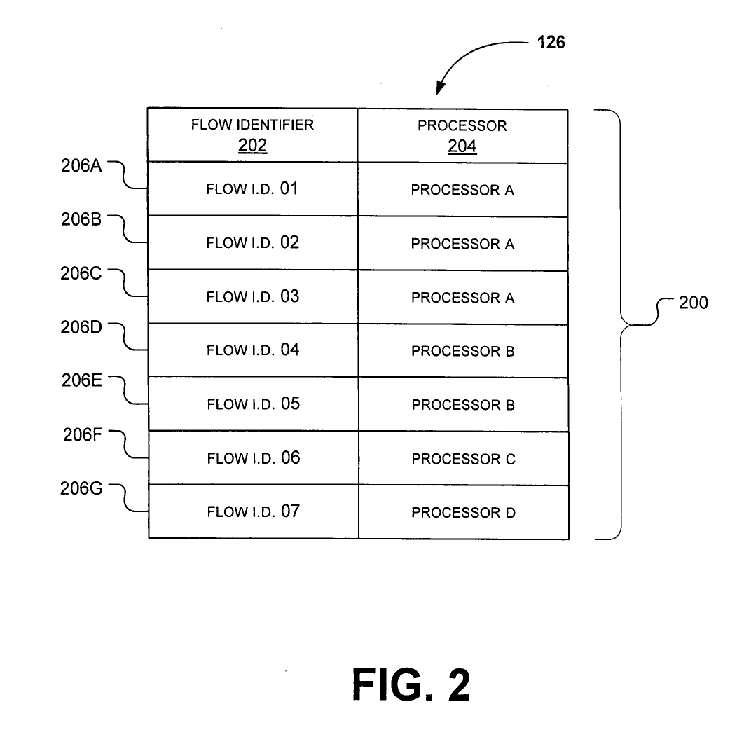

In an embodiment, network controller 126 may be compatible with a flow-based processor affinity scheme, and direct packets 140 to one or more processors 102A, 102B, . . . , 102N based, at least in part, on a flow of the packets 140. Furthermore, network controller 126 may receive feedback from the one or more processors 102A, 102B, . . . , 102N indicating a request to redirect one or more packets 140. As illustrated in FIG. 2, network controller 126 may comprise a mapping table 200 used to direct packets 140 to processors 102A, 102B, . . . , 102N. Mapping table 200 may comprise one or more entries 206A, 206B, 206C, 206D, 206E, 206F, 206G, where each entry may be indexed into using a flow identifier 202 to obtain a corresponding processor 204. As illustrated in FIG. 2, a single flow may be mapped to a single processor: flows having flow identifier 06 may be mapped to processor C, and flows having flow identifier 07 may be mapped to processor D. Additionally, multiple flows may be mapped to a single processor: flows having flow identifiers 01, 02, or 03 may be mapped to processor A, and flows having flow identifiers 04 or 05 may be mapped to processor B.

System 100 may comprise more than one, and other types of memories, buses, and network controllers; however, those illustrated are described for simplicity of discussion. Processors 102A, 102B, . . . , 102N, memory 104, and busses 106,110, 112 may be comprised in a single circuit board, such as, for example, a system motherboard 118, but embodiments of the invention are not limited in this respect.

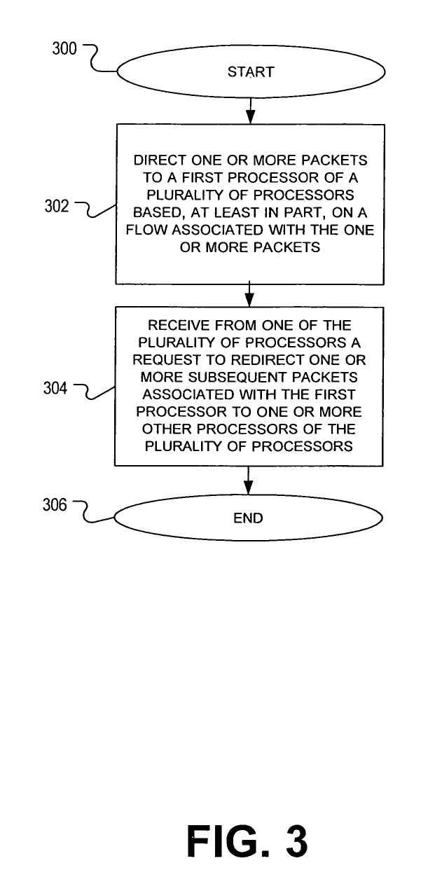

A method according to an embodiment is illustrated in FIG. 3. The method of FIG. 3 begins at block 300 and continues to block 302 where the method may comprise directing one or more packets to a first processor of a plurality of processors based, at least in part, on a flow associated with the one or more packets. For example, network controller 126 may direct one or more packets 140 to a first processor 102A, of a plurality of processors 102A, 102B, . . . , 102N based, at least in part, on one or more flows associated with the one or more packets, where first processor 102A may be an arbitrary one of plurality of processors 102A, 102B, . . . , 102N. The one or more flows directed to the first processor may be associated with the same flow, or may be associated with different flows. Network controller 126 may determine which processor to select for a given flow by indexing a flow identifier associated with the given flow into a mapping table, and selecting the processor corresponding to the flow identifier. Network controller 126 may also append the flow identifier to each packet 140.

In an embodiment, such as in an RSS environment, network controller 126 may receive a packet 140, and may generate an RSS hash value. This may be accomplished by performing a hash function over one or more header fields in the header of the packet 140. One or more header fields of packet 140 may be specified for a particular implementation. For example, the one or more header fields used to determine the RSS hash value 112 may be specified by NDIS. Furthermore, the hash function may comprise a Toeplitz hash as described in the WinHEC Apr. 19, 2005 white paper. A subset of the RSS hash value (i.e., flow identifier 202) may be mapped to an entry in an indirection table to obtain a corresponding processor 204 (e.g., 102A, 102B, . . . , 102N).

At block 304, the method may comprise receiving from one of the plurality of processors a signal indicating a request to redirect one or more subsequent packets associated with the first processor to one or more other processors of the plurality of processors. For example, network controller 126 may receive from one of the plurality of processors 102A, 102B, . . . , 102N a signal indicating a request to redirect one or more subsequent packets associated with the first processor 102A to one or more other processors of the plurality of processors 102B, . . . , 102N. In an embodiment, one or more packets 140 received by the processor prior to transmission of the signal may be processed by the processor transmitting the signal.

A “signal” as used herein may refer to an indication of an event. In an embodiment, a signal may comprise a message that includes a flow identifier. As used herein, a message refers to a piece of information sent from one application to another over a communication channel. For example, some messages may be requests made to one application by another, and other messages may deliver data or notification to another application. However, embodiments of the present invention are not limited in this respect.

A signal may be transmitted by a processor 102A, 102B, . . . , 102N in response to a condition, or an event, for example. For example, a signal may be transmitted by an overloaded processor, or an underutilized processor, where overloading or underutilization may be a condition. Similarly, reaching a threshold of packets that can be processed by a specific processor, or a floor of packets that can be processed by a specific processor may specify an event. As used herein, an “overloaded processor” refers to a processor that may meet a condition or event that indicates, for example, a threshold of activity on the processor. As used herein, an “underutilized processor” refers to a processor that may meet a condition or event that indicates, for example, a floor of activity on the processor, such as inactivity. Processors 102A, 102B, . . . , 102N may comprise logic for detecting such events and/or conditions.

Embodiments of the invention are not, however, limited to signals being transmitted from processors on which such conditions and/or events occur. For example, in certain embodiments, signals may be transmitted by one or more designated processors, where such processors may, for example, detect, maintain, or otherwise be aware of conditions and/or events that may occur on other processors.

A request to redirect one or more subsequent packets associated with the first processor to one or more other processors of the plurality of processors may be an explicit request or an implicit request to redirect packets from one processor to one or more other processors. An explicit request refers to data that may indicate specific information that may be used to redirect the packets. For example, the specific information may include the flow identifier of packets to redirect. In an embodiment, an explicit request may be indicated by a signal sent by an overloaded processor, and may provide a flow identifier of subsequent packets to redirect. An implicit request refers to data that may indicate a condition, for example, rather than specific information. For example, the data may indicate an underutilization condition. In an embodiment, an implicit request may be indicated by a signal sent by an underutilized processor, and may simply provide the information that the processor is underutilized. In an embodiment, network controller 126, for example, may subsequently direct one or more packets 140 associated with one or more flows to the underutilized processor. This may or may not be in response to another processor sending a signal indicative of, for example, overloading. Additionally, in certain embodiments, the signal indicating the request may specify the one or more processors 102A, 102B, . . . , 102N to which the one or more subsequent packets 140 are to be redirected.

To determine which one or more subsequent packets it receives may be redirected, network controller may compare flow identifier included with message (“message flow identifier”) to flow identifier included with one or more subsequent packets (“packet flow identifier”). For a given subsequent packet, if message flow identifier and packet flow identifier match, or otherwise correspond (i.e., linked to one another), then the subsequent packet may be redirected.

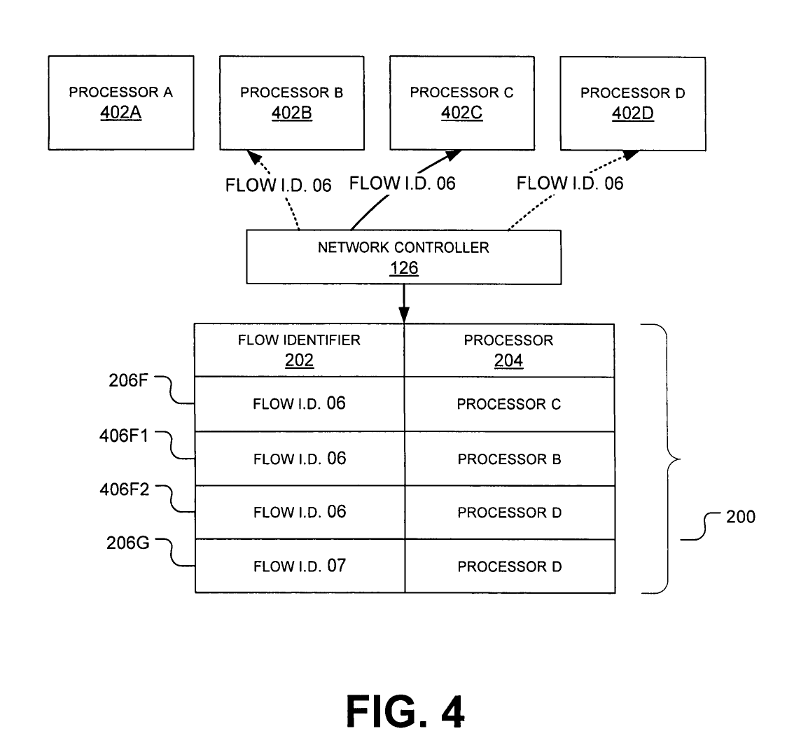

In an embodiment, one or more subsequent packets 140 may be associated with a single flow. In this embodiment, a single flow directed to a first processor may be redirected to one or more multiple processors to load balance the single flow. Turning to FIG. 4, an example of this embodiment is illustrated wherein network controller 126 may initially direct one or more packets 140 associated with the same flow, flow I.D. 06, to processor C 402C (206F) of plurality of processors 402A, 402B, 402C, 402D. One or more subsequent packets 140 associated with flow I.D. 06 may be redirected to processor B 402B, processor C 402C, and processor D 402D, the redirection to the additional processors shown in dotted lines.

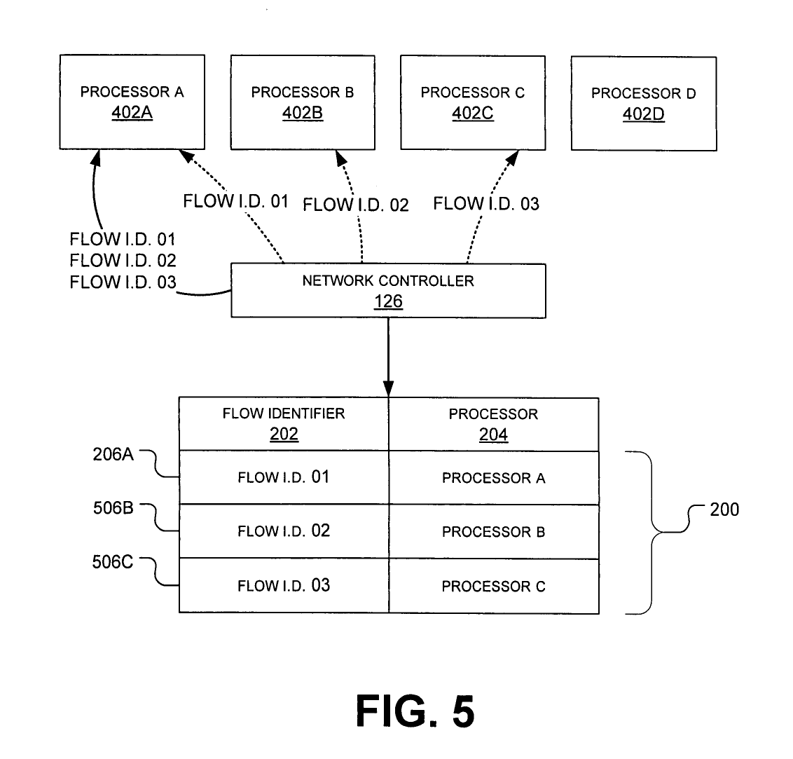

Alternatively, one or more subsequent packets 140 may be associated with multiple flows. In this embodiment, one or more flows directed to a first processor may be dispersed and redirected to one or more other processors. Turning to FIG. 5, an example of this embodiment is illustrated wherein network controller 126 may initially direct one or more packets 140 associated with multiple flows, flow I.D. 01, 02, 03, to processor A 402A (206A) of plurality of processors 402A, 402B, 402C, 402D. One or more subsequent packets 140 associated with flow I.D. 01, 02, 03 may be redirected by redirecting flow I.D. 01 to processor A 402A, flow I.D. 02 to processor B 402B, and flow l.D. 03 to processor C 402C, the redirection of the different flows shown in dotted lines.

Network controller 126 may further update its mapping table. In response to receiving a signal from a processor, network controller 126 may use a flow identifier obtained from a message, for example, to index into its mapping, and change the corresponding processor to another processor. Referring back to FIG. 4, network controller 126 may modify mapping table 200 by, for example, adding entries 406F1 and 406F2 indicating the redirection to the additional processors. Modification of mapping table 200 may be accomplished in other ways without limiting embodiments of the invention. Referring back to FIG. 5, network controller 126 may modify mapping table 200 by, for example, adding entries 506B and 506C indicating the redirection to the additional processors.

Other permutations are possible. For example, a given flow may be mapped to one or more plurality of processors wherein the one or more plurality of processors are all different from the processor to which the given flow was initially mapped.

Furthermore, one or more processors to which one or more subsequent packets are redirected (“redirect processors”) may be selected by various methods. For example, one or more processors may be randomly selected, selected by a round robin method, or may be calculated (e.g., by adding 1 to a current processor, the subsequent processor, etc.). Embodiments of the invention, however, are not limited in this respect. For example, in certain embodiments, it is possible that the redirect processors may be selected by other processors, such as those that send the signals to redirect packets.

Conclusion

Therefore, in an embodiment, a method may comprise directing one or more packets to a first processor of a plurality of processors based, at least in part, on a flow associated with the one or more packets; and receiving from one of the plurality of processors a signal indicating a request to redirect one or more subsequent packets associated with the one processor to one or more other processors of the plurality of processors.

Embodiments of the invention may provide a simple and efficient mechanism to load balance packets across multiple processors in a flow-based processor affinity scheme. Rather than wait for a host protocol stack to periodically adjust a mapping table used to map packets to processors, a signal from the processors is used to dynamically redirect the packets. This may be used to load balance packets associated with a single flow, and may also be used to distribute packets from multiple flows among multiple processors.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

What is claimed is:

1. A method comprising:
directing one or more packets to a first processor of a plurality of processors based, at least in part, on a flow associated with the one or more packets; and
receiving from one of the plurality of processors a signal indicating a request to redirect one or more subsequent packets associated with the one processor to one or more other processors of the plurality of processors.

2. The method of claim 1, wherein each of the one or more subsequent packets is associated with a same flow.

3. The method of claim 1, wherein the signal is received from the first processor of the plurality of processors.

4. The method of claim 1, wherein the signal is received from one of the other processors of the plurality of processors.

5. The method of claim 4, wherein the one of the other processors comprises an underutilized processor.

6. An apparatus comprising:
a network controller to:
direct one or more packets to a first processor of a plurality of processors based, at least in part, on a flow associated with the one or more packets; and
receive from one of the plurality of processors a signal indicating a request to redirect one or more subsequent packets associated with the one processor to one or more other processors of the plurality of processors.

7. The apparatus of claim 6, wherein each of the one or more subsequent packets received on the network controller is associated with a same flow.

8. The apparatus of claim 6, wherein the network controller receives the signal from the first processor of the plurality of processors.

9. The apparatus of claim 6, wherein the network controller receives the signal from one of the other processors of the plurality of processors.

10. The apparatus of claim 9, wherein the one of the other processors comprises an underutilized processor.

11. A system comprising:
a plurality of processors;
a system bus communicatively coupled to the plurality of processors; and
a network controller communicatively coupled to the system bus operable to:
direct one or more packets to a first processor of the plurality of processors based, at least in part, on a flow associated with the one or more packets; and
receive from one of the plurality of processors a signal indicating a request to redirect one or more subsequent packets associated with the one processor to one or more other processors of the plurality of processors.

12. The system of claim 11, wherein each of the one or more subsequent packets is associated with a same flow.

13. The system of claim 11, wherein the signal is received from the first processor of the plurality of processors.

14. The system of claim 11, wherein the signal is received from one of the other processors of the plurality of processors.

15. The system of claim 14, wherein the one of the other processors comprises an underutilized processor.

16. An article of manufacture having stored thereon instructions, the instructions when executed by a machine, result in the following:
directing one or more packets to a first processor of a plurality of processors based, at least in part, on a flow associated with the one or more packets; and
receiving from one of the plurality of processors a signal indicating a request to redirect one or more subsequent packets associated with the one processor to one or more other processors of the plurality of processors.

17. The article of manufacture of claim 16, wherein each of the one or more subsequent packets is associated with a same flow.

18. The article of manufacture of claim 16, wherein the signal is received from the first processor of the plurality of processors.

19. The article of manufacture of claim 16, wherein the signal is received from one of the other processors of the plurality of processors.

20. The article of manufacture of claim 19, wherein the one of the other processors comprises an underutilized processor.
